(19) United States
(12) Patent Application Publication
(10) Pub. No.: US 2009/0012846 A1
(43) Pub. Date: Jan. 8, 2009

(54) COMPUTERIZED BOOK REVIEWING SYSTEM

(75) Inventors: Kevin Ertell, Ann Arbor, MI (US); Lanette Chisnell, Ypsilanti, MI (US); Rich Fahle, Chelesa, MI (US); Manish Vyas, Ann Arbor, MI (US); Margaret Lane, Canton, MI (US); Mark Schneyer, Ann Arbor, MI (US); Cinnamon Melchor, Arlington, VA (US); Suellen Schlievert, Takoma Park, MD (US); Virginia Golden, Washington, DC (US)

Correspondence Address: HARNESS, DICKEY & PIERCE, P.L.C., P.O. BOX 828, BLOOMFIELD HILLS, MI, 48303, US

(73) Assignee: Borders Group, Inc., Ann Arbor, MI (US)

(21) Appl. No.: 12/166,008

(22) Filed: Jul. 1, 2008

Related U.S. Application Data
(60) Provisional application No. 60/958,064, filed on Jul. 2, 2007.

(51) Int. Cl. G06Q 30/00; G06Q 50/00; G06F 3/048

(52) U.S. Cl. 705/10; 705/27; 715/835

(57) ABSTRACT

A user interface system for use with an internet ordering system includes a user-navigable bookshelf environment providing a plurality of columns and rows for displaying items for purchase within item windows aligned along visual representations of shelves bordering the rows. A datastore of item artwork provides visual renderings of items for purchase. An Internet storefront provides a view of a portion of the virtual bookshelf environment to a user. The user interface populates the item windows with item artwork according to predefined criteria, and responds to user interaction with a control of said storefront to change the view of the virtual bookshelf environment presented to the user.

### CROSS-REFERENCE TO RELATED APPLICATIONS

This application claims the benefit of U.S. Provisional Application Ser. No. 60/958064, filed on Jul. 2, 2007. The disclosure of the above application is incorporated herein by reference in its entirety for any purpose.

### FIELD

The present disclosure generally relates to Internet retail advertising and/or ordering systems and, in particular, to a user interface for such systems.

### SUMMARY

A user interface system includes a user-navigable bookshelf environment providing a plurality of columns and rows for displaying items for purchase within item windows aligned along visual representations of shelves bordering the rows. A datastore of item artwork provides visual renderings of items for purchase. An Internet storefront provides a view of a portion of the virtual bookshelf environment to a user. The user interface populates the item windows with item artwork according to predefined criteria, and responds to user interaction with a control of said storefront to change the view of the virtual bookshelf environment presented to the user.

Further areas of applicability will become apparent from the description provided herein. It should be understood that the description and specific examples are intended for purposes of illustration only and are not intended to limit the scope of the present disclosure.

### DRAWINGS

FIG. 1, including FIGS. 1A and 1B, is a set of views illustrating a computerized book reviewing system in which an internet storefront has a virtual bookshelf environment in which images representing items and promotions populate a virtual bookshelf.

FIG. 2 is a block diagram illustrating a computerized book reviewing system.

FIG. 3 is a block diagram illustrating a 2D object/image matrix.

FIG. 4, including FIGS. 4A-4C, is a set of views illustrating animation of vertical movement of a virtual bookshelf within a frame.

FIG. 5, including FIGS. 5A-5D, is a set of views illustrating animation of vertical movement of a 2D object/image matrix within a frame.

FIG. 6, including FIGS. 6A-6D, is a set of views illustrating synchronous animation, within the same frame, of vertical movement of a virtual bookshelf and a 2D object/image matrix.

FIG. 7, including FIGS. 7A-7C, is a set of views illustrating a virtual bookshelf environment achieved by synchronous animation, within the same frame, of vertical movement of a virtual bookshelf and a 2D object/image matrix.

FIG. 8, including FIGS. 8A and 8B, is a set of views illustrating a virtual bookshelf environment achieved by animation, within a frame, of horizontal movement of an individual row of an object/image matrix.

FIG. 9, including FIGS. 9A and 9B, is a set of views illustrating animation, within a frame, of horizontal movement of an individual row of an object/image matrix.

FIG. 10, including FIGS. 10A-10D, is a set of views illustrating population of the object/image matrix with promotions, and a virtual bookshelf environment thus achieved.

FIG. 11, including FIGS. 11A-11C, is a set of views illustrating promotions employed to populate the object/image matrix.

FIG. 12 is a set of views illustrating promotions modifying item images populating the object/image matrix.

FIG. 13 is a block diagram illustrating a user interface and Internet advertising/ordering system.

FIG. 14 is a block diagram illustrating components of the user interface and Internet ordering system of FIG. 13.

FIG. 15 is a graphical representation illustrating an Internet storefront providing a view of a user navigable virtual bookshelf environment.

FIG. 16 is a graphical representation illustrating user navigation within a category of the virtual bookshelf environment.

FIG. 17 is a graphical representation illustrating user navigation to another category of the virtual bookshelf environment.

FIG. 18 is a graphical representation illustrating a promotional sign interspersed onto the virtual bookshelf environment.

FIG. 19 is a graphical representation illustrating an exemplary interface for specifying user preferences.

FIG. 20 is a graphical representation illustrating an exemplary category configured based upon user specified preferences.

FIG. 21 is a graphical representation illustrating a display of item-specific information in response to user interaction with item artwork rendered in the virtual bookshelf environment.

FIG. 22 is a graphical representation illustrating an exemplary interface for reserving an item at a store location.

The drawings described herein are for illustration purposes only and are not intended to limit the scope of the present disclosure in any way.

### DETAILED DESCRIPTION

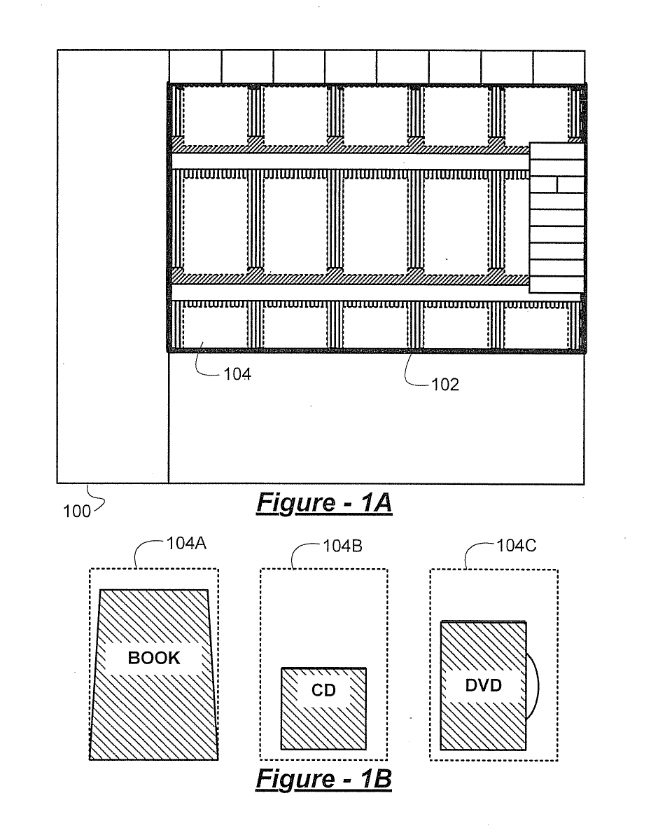

Referring generally to FIG. 1, an embodiment of the computerized book reviewing system provides an internet storefront 100 having a virtual bookshelf environment 102 and item artwork 104 populating the virtual bookshelf. The item artwork 104 represents specific software objects for reviewing information about specific items for purchase. The items for purchase are of various types, including books, CDs, and DVDs. Accordingly, various types of icons representing the purchasable items are employed to communicate the type of item. Thus, types of item artwork include book 104A, CD 104B, and DVD 104C. Images representing the items for purchase are rendered on the item artwork, and the item artwork has a size and shape determined by item type and sizes and shapes of specific items for purchase. It is envisioned that other types of items can be sold using the virtual bookshelf, such as gift cards, plush toys, candy, and many other types of goods and services.

As further explained below, other types of item artwork, and especially promotions regarding all items, categories of items, and specific items, populate the virtual bookshelf. These types of item artwork contain images and graphics representing the promotions, and appear to be signs promoting the items for purchase. As additionally explained below, images representing promotions specific to the items for purchase are incorporated into the item artwork representing the items for purchase. This promotion image incorporation appears as tags and stickers attached to fronts of books, CDs, and DVDs.

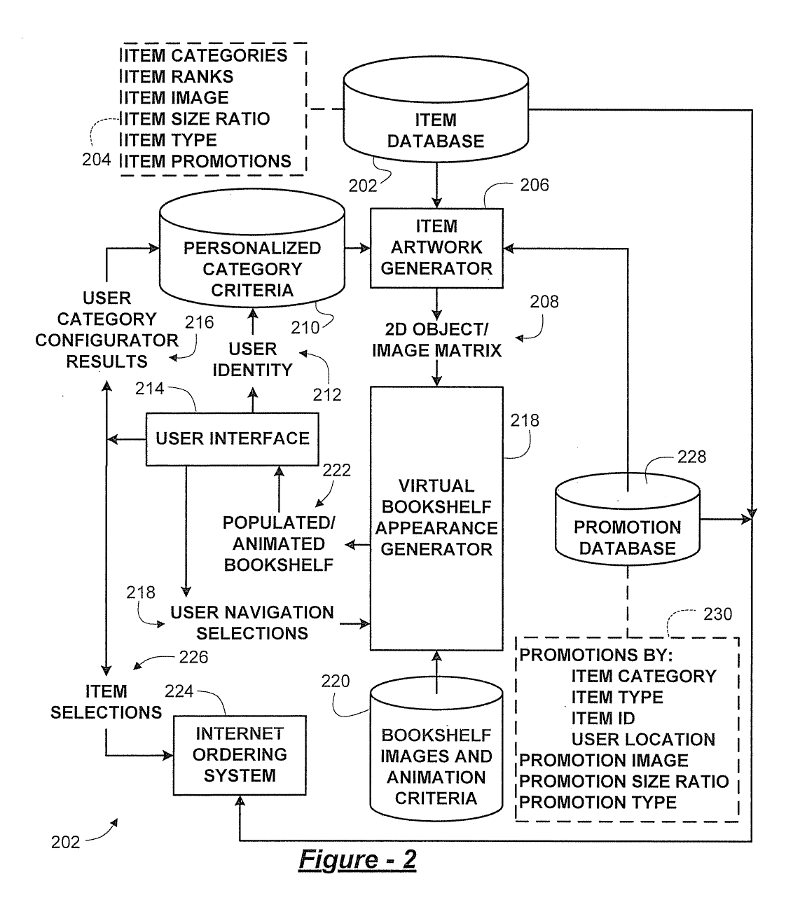

Turning now to FIG. 2, the computerized book reviewing system 200 has an item database 202 storing information about specific items for purchase. A data object 204 describing an item identifies the item's item categories, rank within each category, item image, item size ratio, item type, and item promotions. The item categories identify the categories to which the item has been assigned, and its rank assigned rank in each category. The item promotions identify those promotions that are relevant to the item and therefore suitable for adding to the image of the item front and for display on the shelf proximate to the item icon representing the item.

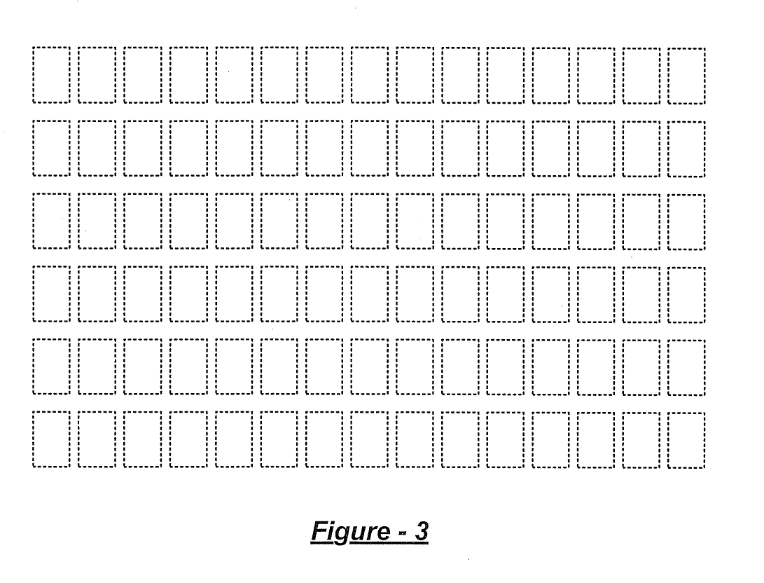

An item artwork generator 206 retrieves information about items for predefined categories from database 202 and generates a 2D object/image matrix 208 illustrated in FIG. 3. The object/image matrix has rows of object/images for each of the categories in which objects and the icons representing the objects are arrayed. The object/images are arranged from left to right according to their ranks within the categories. Each of the object images has a size, shape, and image content according to information specified by the data object 204 (FIG. 2) for the item. For example, item image and size ratio are used to generate an image for the item object, especially in the case of books, which vary in size and proportion. Item type is also used to determine item size and shape, as in the case of a CD and DVD, and to add additional graphics, such as a DVD graphic protruding from the image for a DVD.

One or more of the categories is a personalized category for a user. In the personalized category, item objects belonging to multiple categories are retrieved and their object/images grouped together in a row according to their ranks within those categories. The categories are provided by personalized category criteria database 210 according to a user identity 212 supplied by the user interface 214. The user interface populates the database 210 by employing a configurator tool by which users select the categories. The configurator tool supplies results 216 for each user to database 210. Additional criteria supplied by results 216 include criteria for selecting items by artist/writer, keywords, and criteria for deselecting items by category, artist, and keywords. Following purchases, Internet ordering system 224 supplies a user purchase history to database 210. Database 210 stores the criteria together with the user purchase history to item artwork generator 206, which employs all of these criteria to populate personalized user rows and to re-rank object/images within each of the rows, including those which are not personalized.

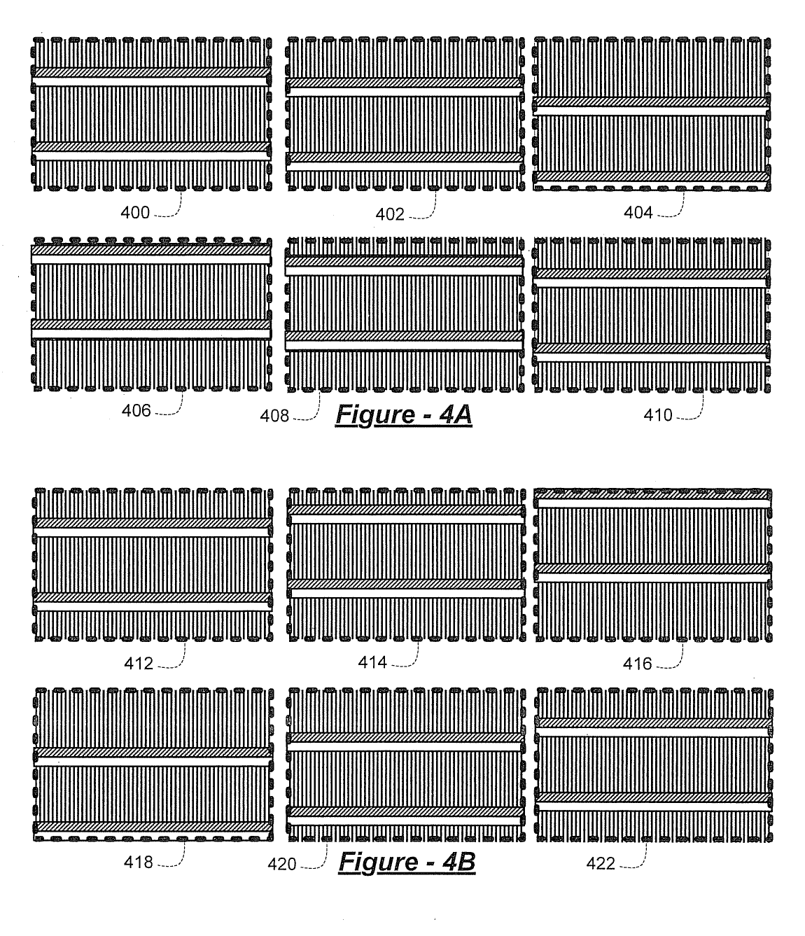

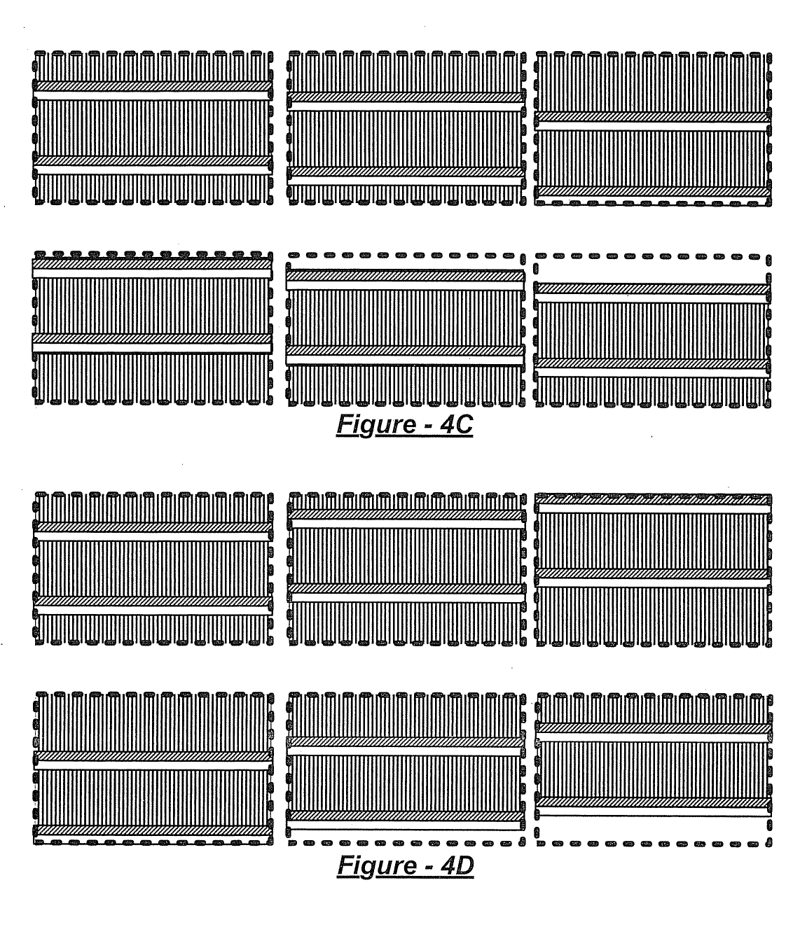

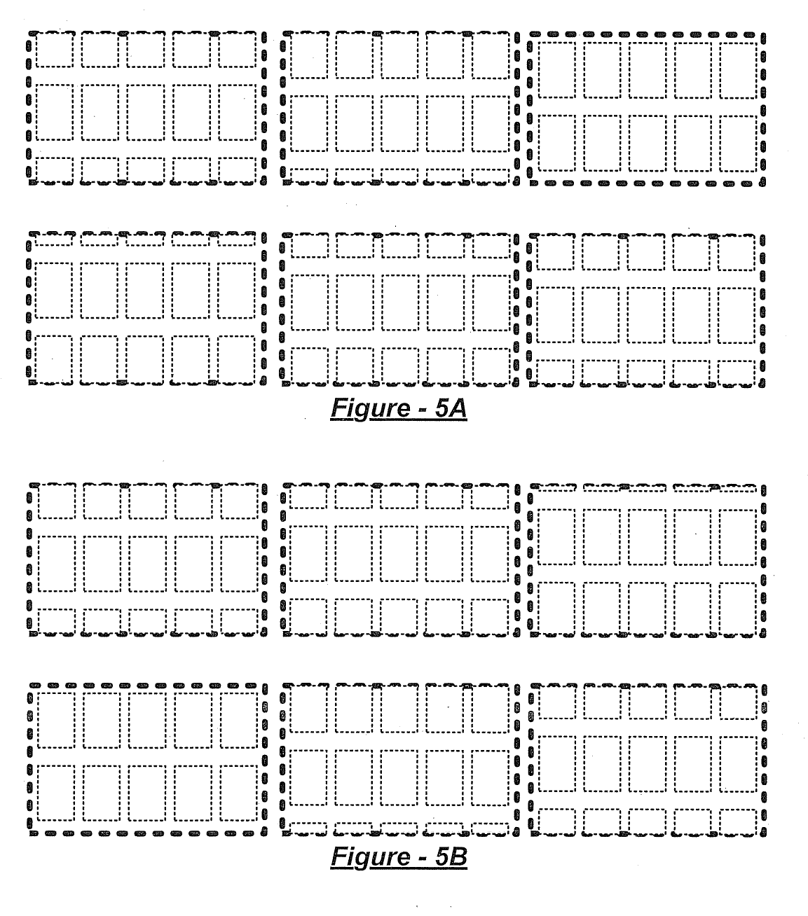

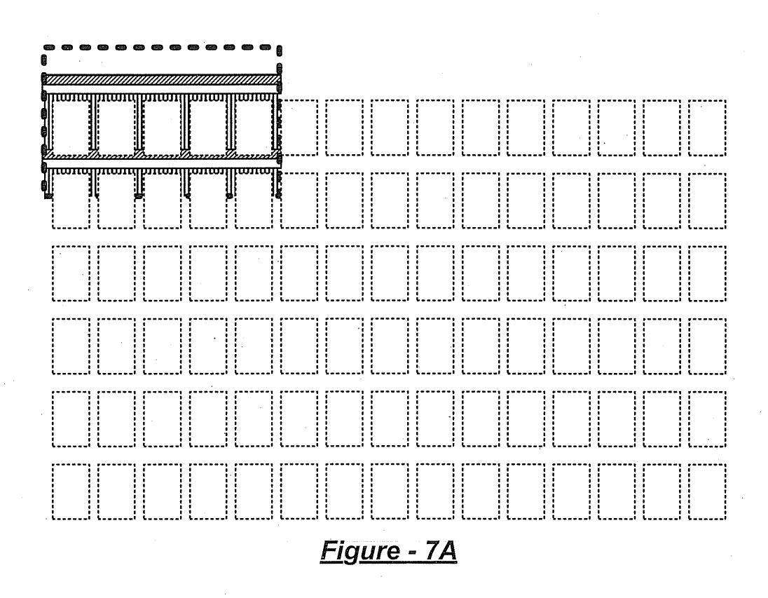

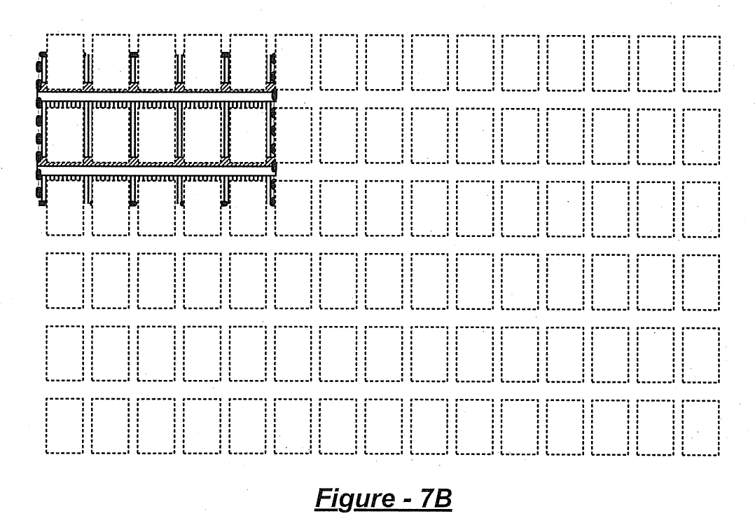

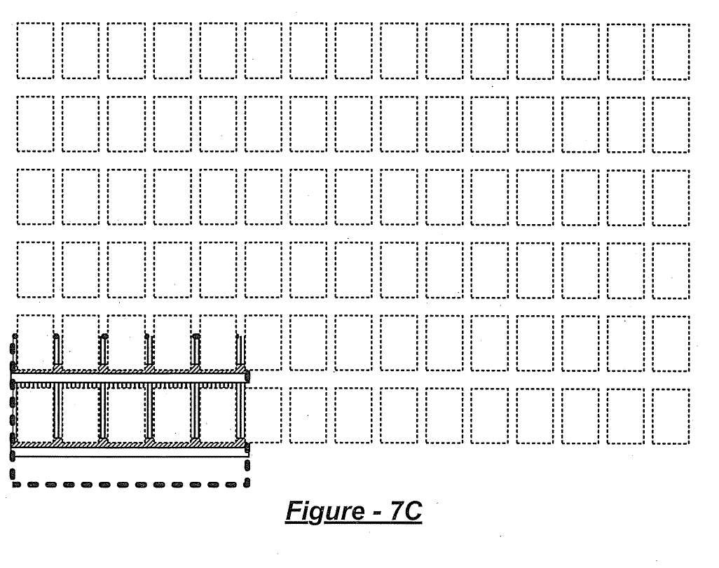

Virtual bookshelf appearance generator 218 receives the 2D object/image matrix 208. Bookshelf appearance generator 218 has an animation engine that retrieves an initial bookshelf image from database 220, which contains a number of bookshelf images and animation criteria. For example, bookshelf appearance generator retrieves an initial bookshelf background image like the one in FIG. 4A illustrated at 400, and initially populates it with object/images as illustrated in FIG. 7B. This populated virtual bookshelf 222 (FIG. 2) is supplied to user interface 214, which displays the virtual bookshelf 222 in a frame of the internet storefront 100 (FIG. 1A). User interface 214 adds a grey border to the item images that creates an appearance of depth for the item images. This border changes color when the user places a pointer over the item image to indicate the current focus for selecting to view information about an item. The user makes an item selection 226 by clicking on the item image. Internet ordering system 224 receives item selections 226 from user interface 214 and displays information about the items for purchase to the user.

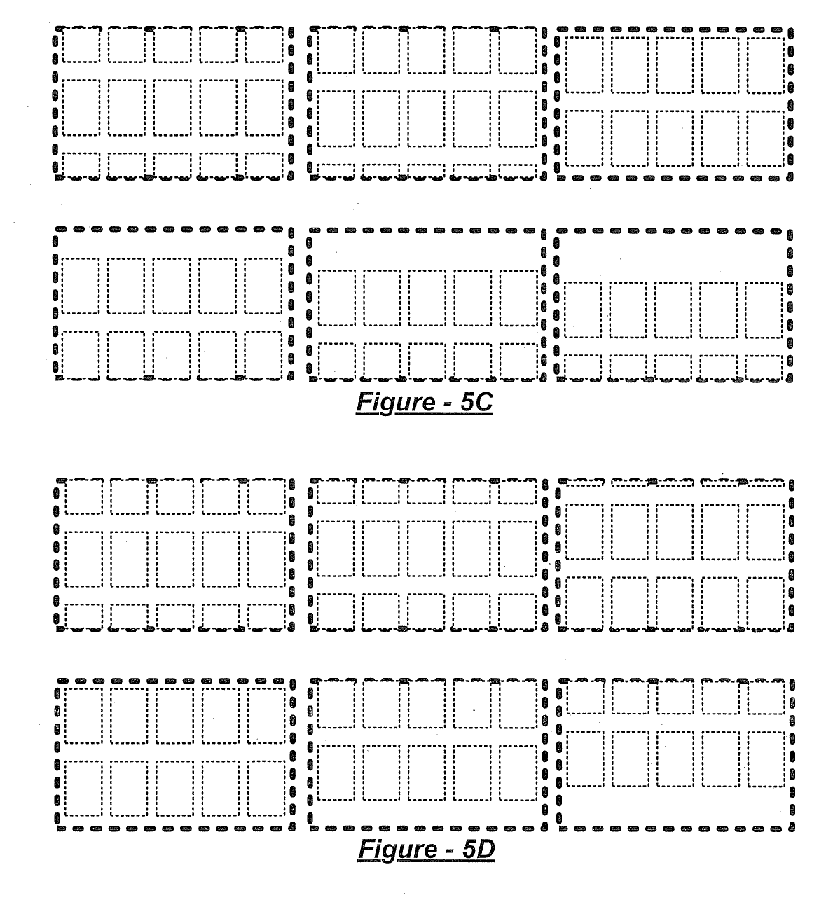

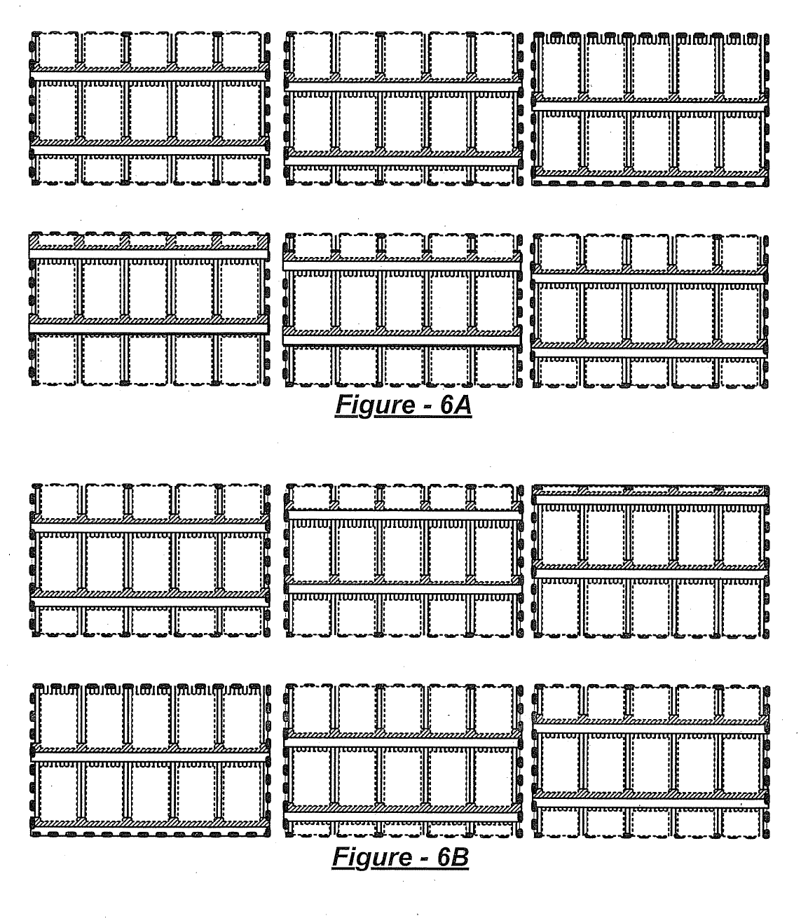

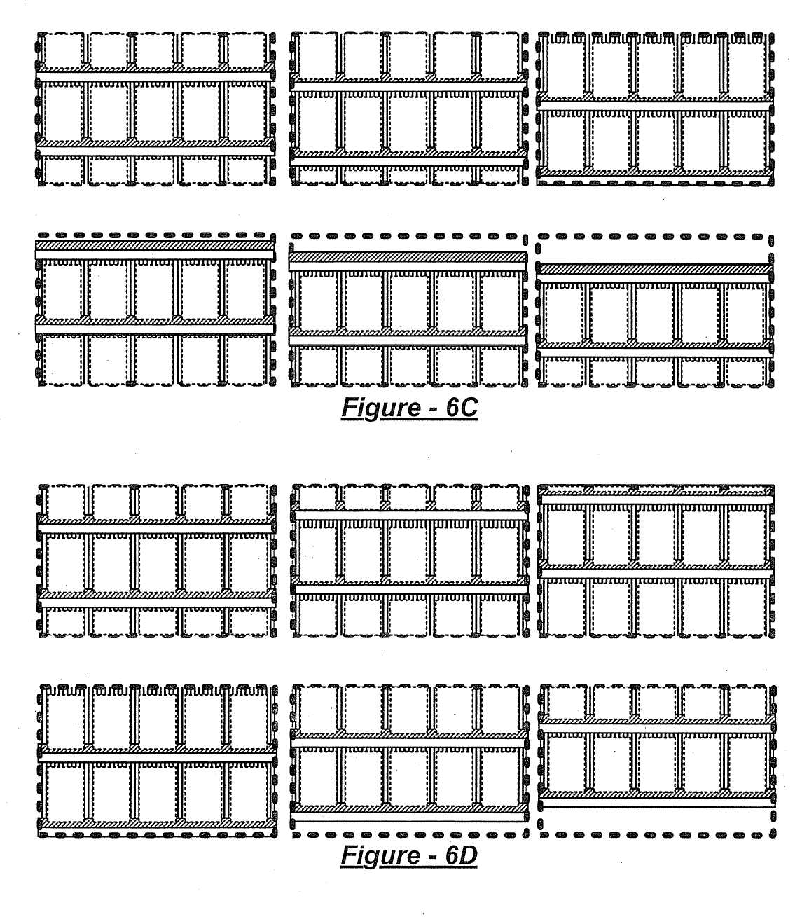

Virtual bookshelf appearance generator 218 receives user navigation selections 228 from user interface 214, such as category selections and horizontal movement selections. In response to a category selection, the animation engine of the bookshelf appearance generator recursively retrieves a sequence of bookshelf background images like those illustrated in FIG. 4. For example, bookshelf background images of FIG. 4A are retrieved in a sequence 400, 402, 404, 406, 408, and 410 to animate the bookshelf moving down. The animation engine synchronously populates the animated shelf with item images of the matrix as illustrated in FIG. 5A and FIG. 6A. Item images are chosen from an immediately upper row of the matrix to populate a bookshelf entering the frame from above. Item images in a bottom row of the bookshelf are drawn from a top corner of the item object position to a frame edge, while item images in a top row of the bookshelf are drawn from a bottom corner of the item object position to a frame edge. Thus, the user experiences a change of focus upwards to a shelf above the previous shelf.

Referring to FIG. 4B, the animation engine animates the bookshelf background images in a reverse sequence 412, 414, 416, 418, 420, and 422 in order to present the bookshelf as moving upward in the frame. In this case, the animation engine synchronously populates the animated shelf with item images of the matrix as illustrated in FIG. 5B and FIG. 6B. Here, item images are chosen from an immediately lower row of the matrix to populate a bookshelf entering the frame from below. Again, item images in a bottom row of the bookshelf are drawn from a top corner of the item object position to a frame edge, while item images in a top row of the bookshelf are drawn from a bottom corner of the item object position to a frame edge. Thus, the user experiences change of focus downwards to a shelf below the previous shelf.

By performing the synchronous bookshelf and item artwork animations as described above, the animation engine responds to user category navigation selections by navigating upwards and downwards in the virtual bookshelf environment from bookshelf to bookshelf and from item artwork row to item artwork row. These animations are performed in a stepwise fashion to recursively navigate to the bookshelf for the user selected category in a scrolling fashion. When a top of the item object/image array is reached, the animation engine selects a sequence of background images like those illustrated in FIG. 4C. The animation engine synchronously populates the animated bookshelf with item images as illustrated in FIGS. 5C and 6C. Thus the user experiences a change of focus to a top of the bookshelf. Similarly, when a bottom of the item object/image array is reached, the animation engine selects a sequence of background images like this illustrated in FIG. 4D. The animation engine synchronously populates the animated bookshelf with item images as illustrated in FIGS. 5D and 6D. Thus the user experiences a change of focus to a bottom of the virtual bookshelf. Accordingly, the user navigates from a top bookshelf (FIG. 7A) to an immediately lower bookshelf (FIG. 7B) by selecting the appropriate category. Also, the user navigates all the way down to a bottom shelf (FIG. 7C) by selecting the category for that shelf. The animation engine thus provides a smooth vertical scrolling experience to the user.

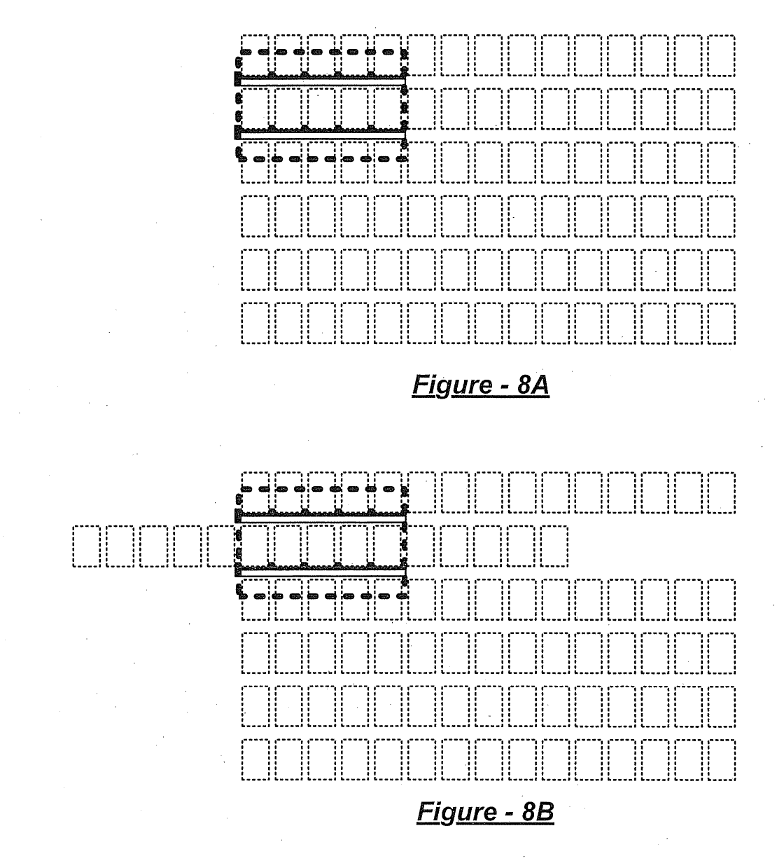

Turning now to FIGS. 8 and 9, the animation engine additionally responds to user navigation selections within a row having the focus by animating horizontal movement of item images only in that row. Thus, when the user selects to view a next five set of item images within the current row, the item images in that row scroll horizontally to the next five images as illustrated in FIG. 8. Animation engine achieves the smooth animation of horizontal scrolling for a row while keeping a current bookshelf background image constant as illustrated in FIG. 9. For example, the item object/image positions for only the center row are moved left in steps according to a sequence 900, 902, 904, and 906. An item image for an item object entering the frame from the right is selected as the next item object/image in that row of the matrix. A leftmost item image is drawn from a right corner to an edge of the frame, while a rightmost item image is drawn from a left corner to an edge of the frame. This animation is recursively performed five times in a stepwise fashion to treat the user to an appearance of a previous five item images smoothly exiting the frame to the left as the next five item images smoothly enter the frame from the right. The opposite animation is performed when the user selects to navigate to a previous five item images.

Returning now to FIG. 2, item artwork generator 206 also accesses promotion database 228 and uses data objects 230 to retrieve information about promotions. For example, the information about a promotion includes item categories, item types, item IDs, and locations at which the promotions are valid. The information also includes a promotion image, promotion size ratio, and promotion type.

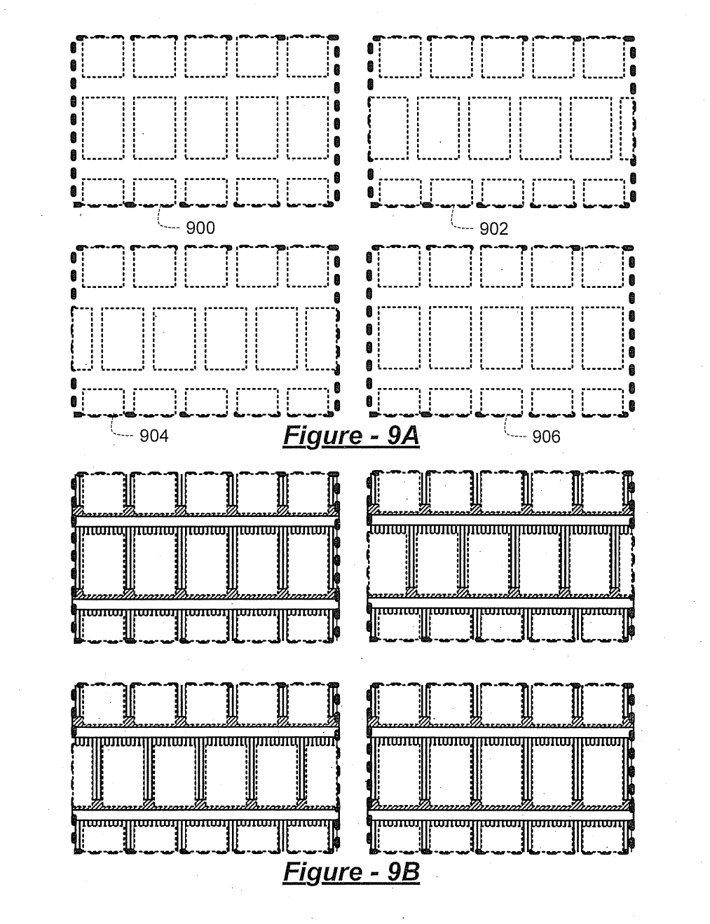

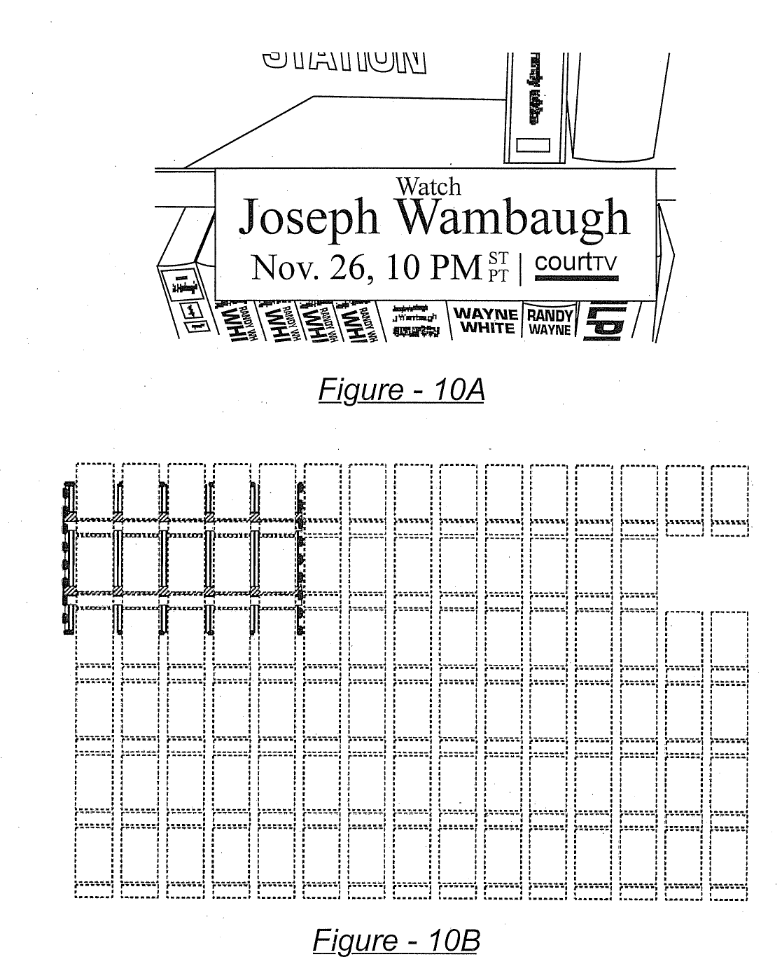

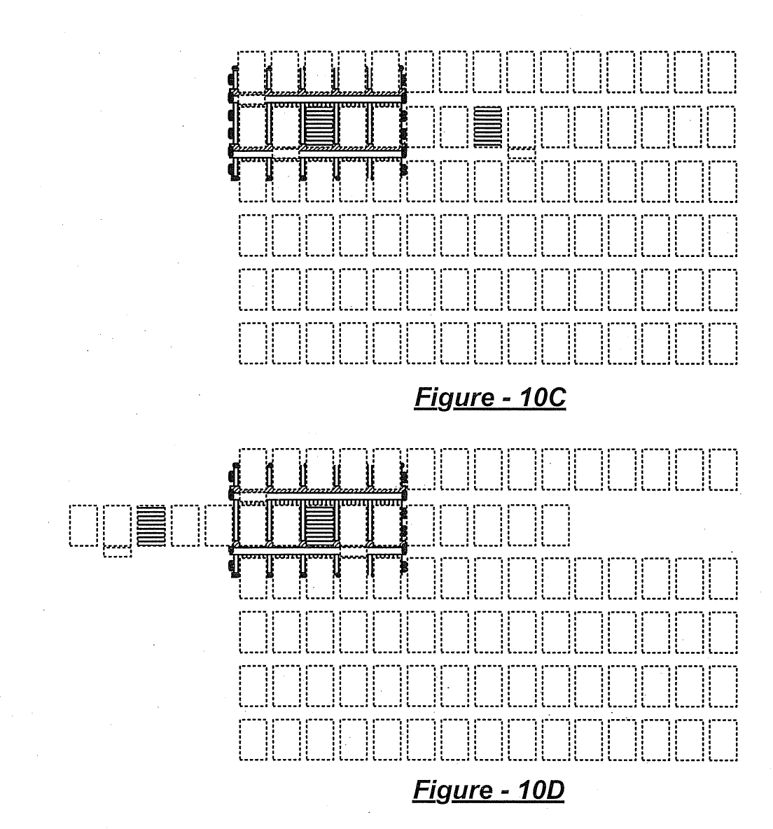

Turning to FIG. 10, one type of promotion simulates an appearance of in-store promotions displayed by attachment to shelves. Such promotions are item specific, author specific, and location specific. For example, the promotion advertises an event occurring in a user's location that pertains, for example, to an author or artist of a purchasable item. Some of these types of promotions are paid for by advertisers, such as a publishing company, record company, Television Company, or other media outlet. In one example, upcoming book signings by authors and interviews with authors occurring in a user's location are added to the object/item matrix proximate to such a book. In another example, upcoming concerts in a user's area by artists of a CD are selected for addition to the object/item matrix proximate to such a CD icon. Additional advertisers that pay for such promotions are equipment retailers, such as sports equipment, gaming equipment, and arts and crafts retailers. For example, a promotion for golf equipment is selected and added to the object/item matrix proximate to a book or DVD pertaining to golf.

Some images of these types of promotions are displayed immediately below the item to which they pertain. This display technique achieves an appearance of a virtual bookshelf promotion display like the types of promotion displays that are present in retail locations. Also, this display technique ensures that an advertisement of this type is always supplied in proximity to the item to which it pertains. As a result, items in a category do not need to be removed in order to make room for placement of the promotions on the shelves. In addition, some of these promotions are displayed on the virtual bookshelf proximate next to the items to which they pertain.

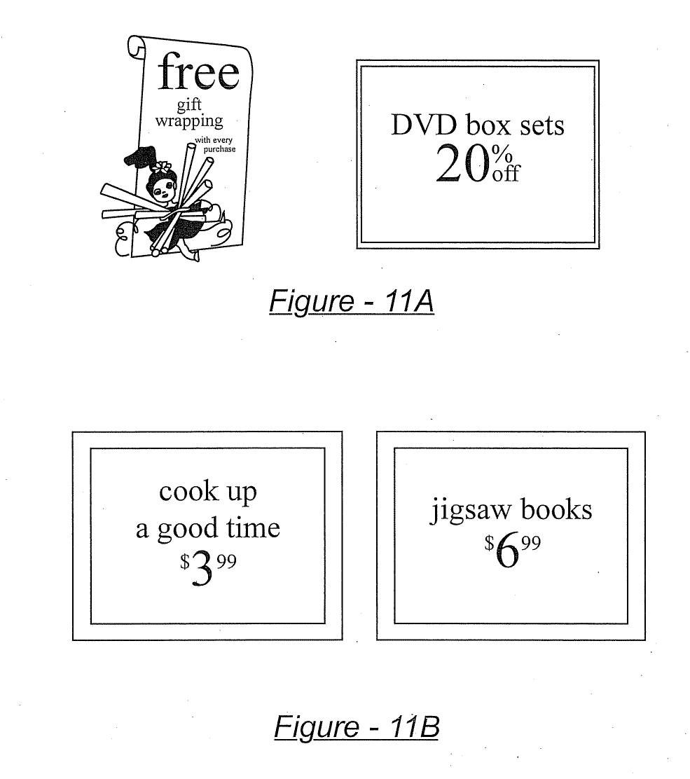

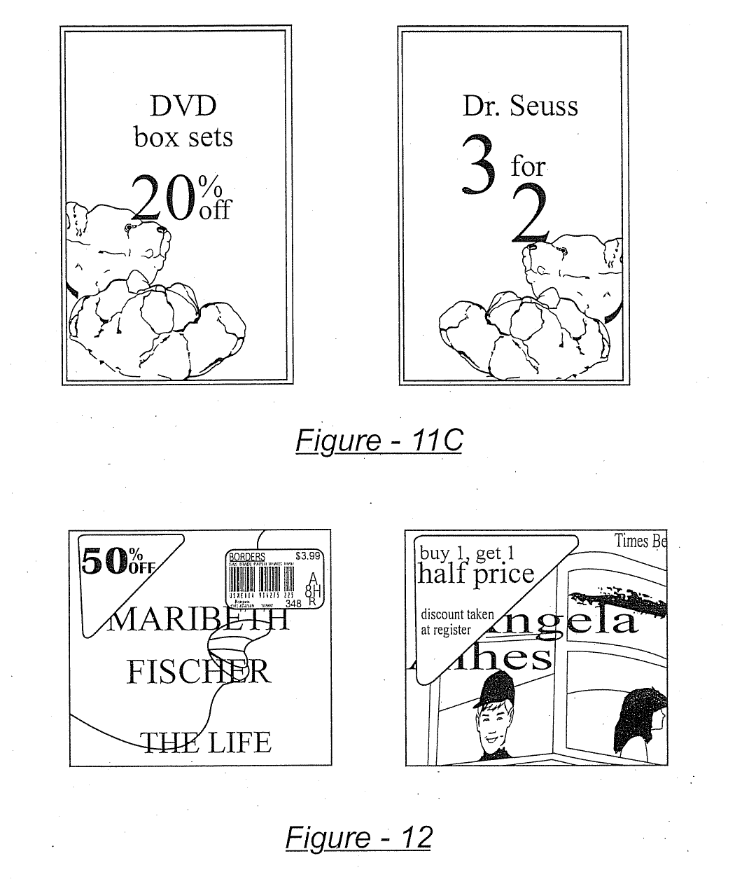

Referring now to FIG. 11, promotions that pertain to a category or item are displayed on the bookshelves to which they pertain in place of item images. Such a promotion pertains to a bookshelf when it pertains to a category of a bookshelf or to an item displayed on the bookshelf. Also, some promotions are more generic and are displayed on any of the bookshelves. In these cases, the promotion images and size ratios are used to determine the appearance of the promotion on the bookshelves. These promotions are employed to fill a row (FIG. 10B) that does not have enough items available. Unless the promotions pertain to a particular item/object, the promotions are placed into the object/item matrix at positions that ensure that the promotion images are displayed at a center of the bookshelf as illustrated at FIG. 10. Then, when items on a shelf are horizontally scrolled, the promotions displayed beside and below item images are also animated to scroll into and out of the frame.

Some of the promotions that are placed on or below bookshelves are linked to information pages, such as lists of items for purchase, and external websites of advertisers. Thus, when a user clicks on a promotion advertising a discount on bargain books, the user is presented with a virtual bookcase filled with bargain books at a location nearest the user or preferred by the user. Also, when a user clicks on a promotion paid for by an advertiser, such as sports equipment promotion displayed proximate to an item image for a purchasable item pertaining to sports, the user navigates to a website of the advertiser that permits the user to order items, such as sports equipment.

Turning now to FIG. 12, additional types of promotions include stickers for altering item images. In this case, an image for the sticker is rendered into a predetermined position on the item image. These stickers are retrieved by store location in an area proximate to the user location. Then, when the user click on the item image, a number of store locations are presented to the user with an indication regarding which promotions are available at which location. In the case of different promotions available at different locations near the user, a promotion selection process is used. In this case, promotions that provide the most discount and lowest overall price are given more weight in the promotion selection process. Additionally, promotions that are available at locations nearest the user are given more weight in the promotion selection process. These weighted promotion selection processes are also employed to select promotions of the type that are displayed on the bookshelves, and user purchasing history is additionally used to weight promotion selection.

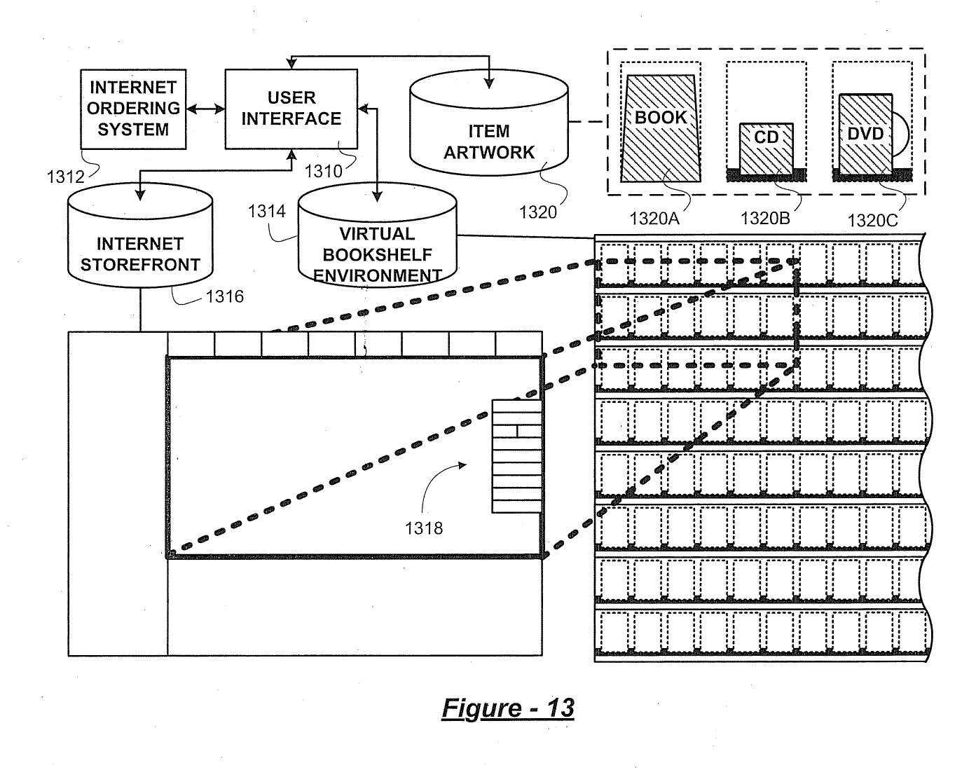

With reference to FIG. 13, another embodiment of the computerized book reviewing system includes a user interface 10 for use with an internet advertising and/or ordering system 1312. User interface 1310 has a user-navigable, virtual bookshelf environment 1314 providing a plurality of columns and rows for displaying items for purchase within item windows aligned along visual representations of shelves bordering the rows. A data store stores item artwork 1320 providing a visual rendering of items for purchase. An Internet storefront 1316 provides a view of a portion of the virtual bookshelf environment to a user. The user interface populates the item windows with item artwork 1320 according to predefined criteria, and responds to user interaction with a control 1318 of the storefront 1316 to change the view of the virtual bookshelf environment 1314 presented to the user.

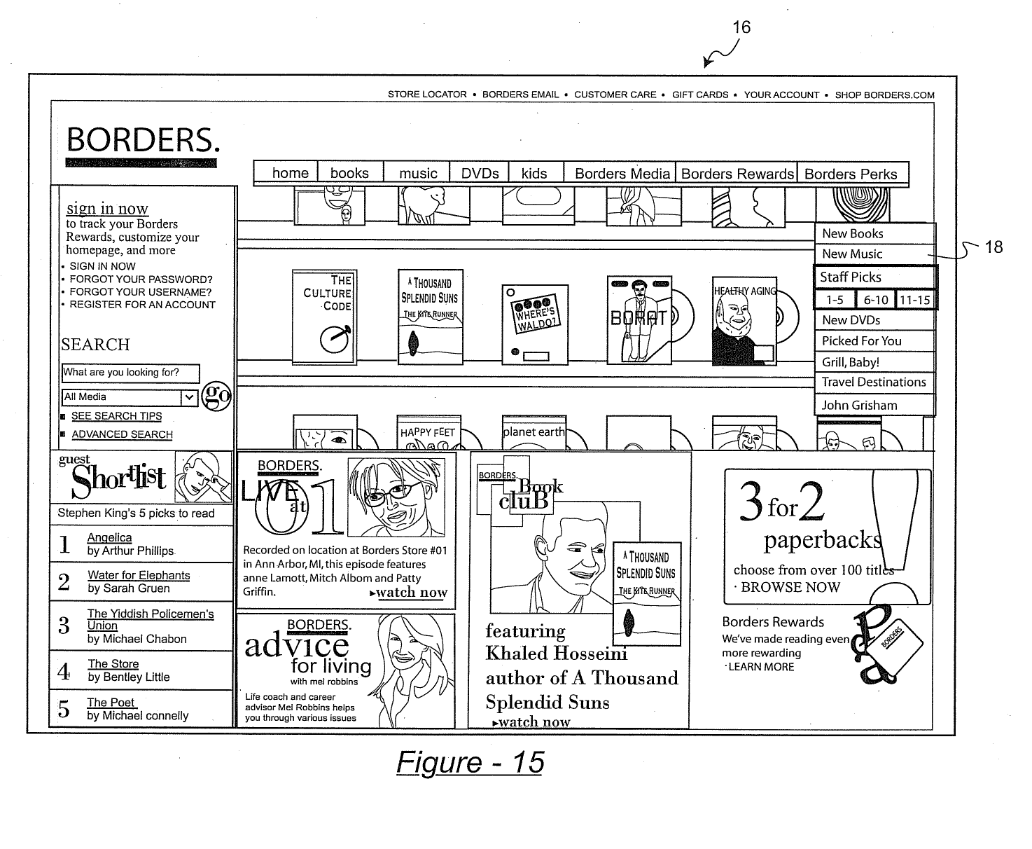

Turning now to FIG. 15, in order to achieve seamless appearance of the items rendered as if displayed on the shelves, the item artwork contain elements of the visual representations of the shelves. For example, the visual representations of the shelves and the item artwork have depth components, in which case the depth components of the item artwork are configured to complement the depth components of the visual representations of the shelves. Example depth components include perspective and light and shadow, so that rendered of the shelves allow them to appear to be completed behind and underneath the items, and the items appear to rest on the shelves and lean back. Also, the elements of the visual representations of the shelves include shelf color pattern, in which case the color patterns of portions of the artwork match the shelves so as to complete the shelves as rendered behind and underneath the items. In this way, the virtual bookshelves are intended to look like actual shelves.

Returning now to FIG. 13, the item artwork 1320 employs different conventions for representing different types of items in a visually differentiable fashion. For example, a book shape 1320A, a CD shape 1320B, and a DVD shape 1320C are used. Item covers are rendered on and within the strictures of the shapes. It is envisioned that other types of items are also displayed on the interface.

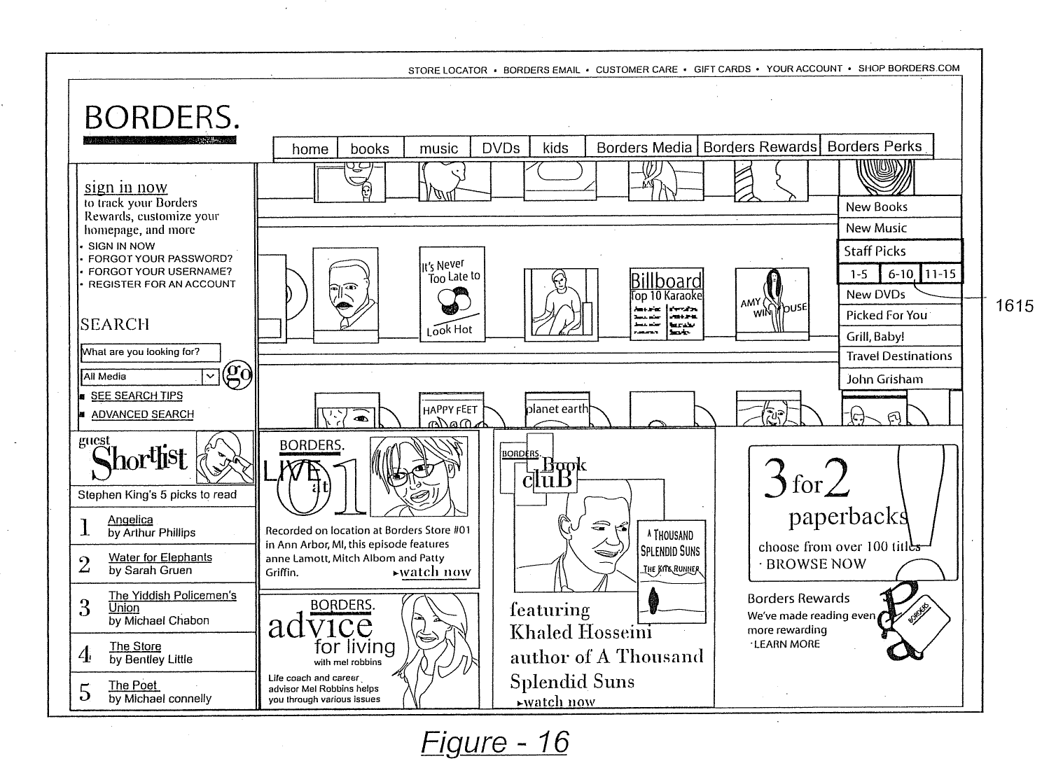

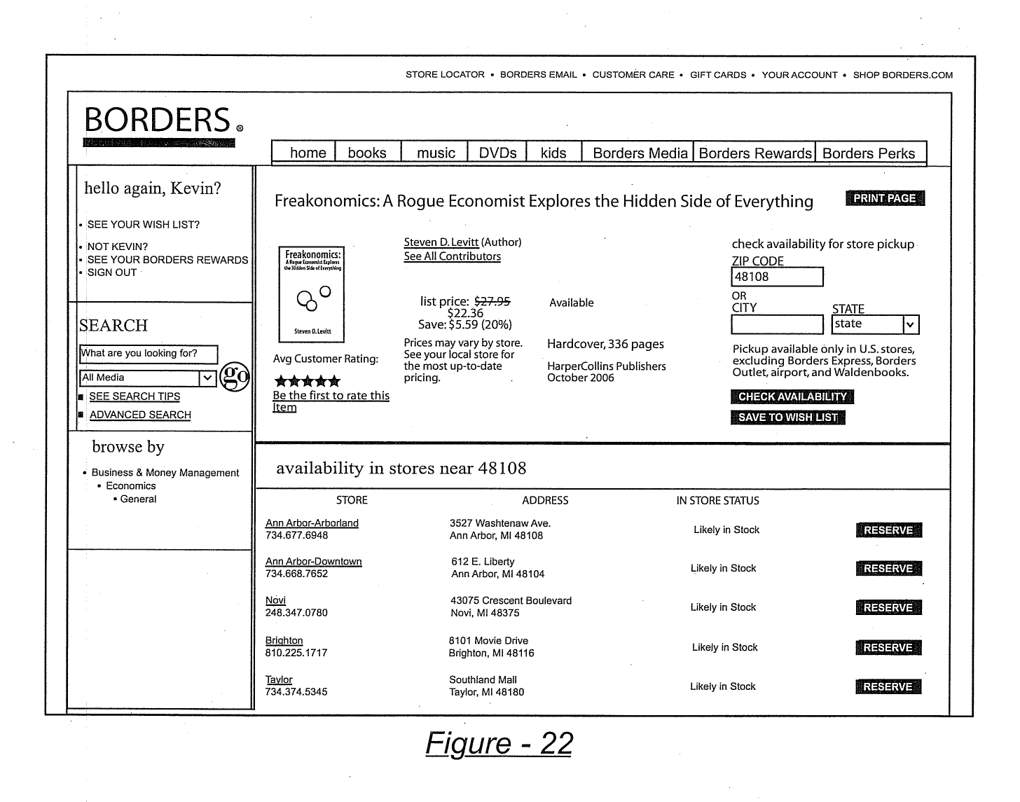

Turning now to FIGS. 15-22, the storefront 16 provides hierarchically arrayed, user-selectable, user interface components 18 conveying categories assigned to the rows. User selection of the components enables the user to view different items on the bookshelf. For instance, a user scrolls along a row in a lateral direction as shown in FIG. 16. To do so, the user selects the component indicated at 1615 which correlates to the next five items within a given category. In response, the user interface renders the item artwork for the next five items onto the shelves.

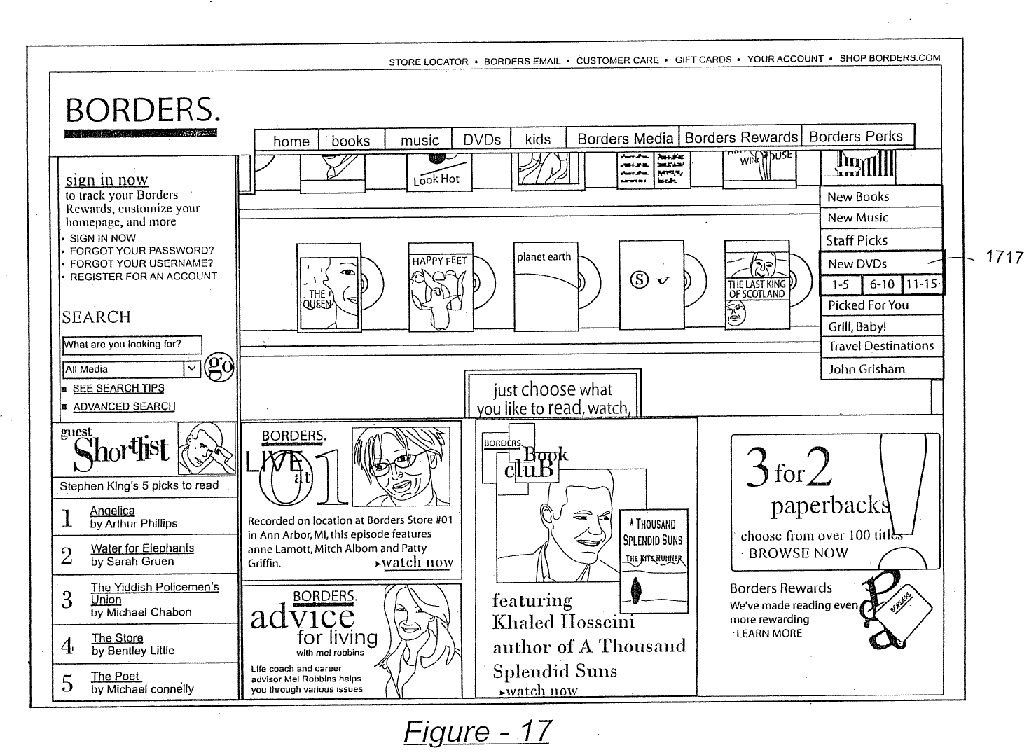

Alternatively, the user scrolls between rows (i.e., between shelves) in a vertical direction as shown in FIG. 17. To do so, the user selects one of the other components indicated at 1717 which indicate a different category of items. In this example, the user switches from the “Staff Picks” category as shown in FIGS. 15 and 16 to the “New DVDs” category as shown in FIG. 17.

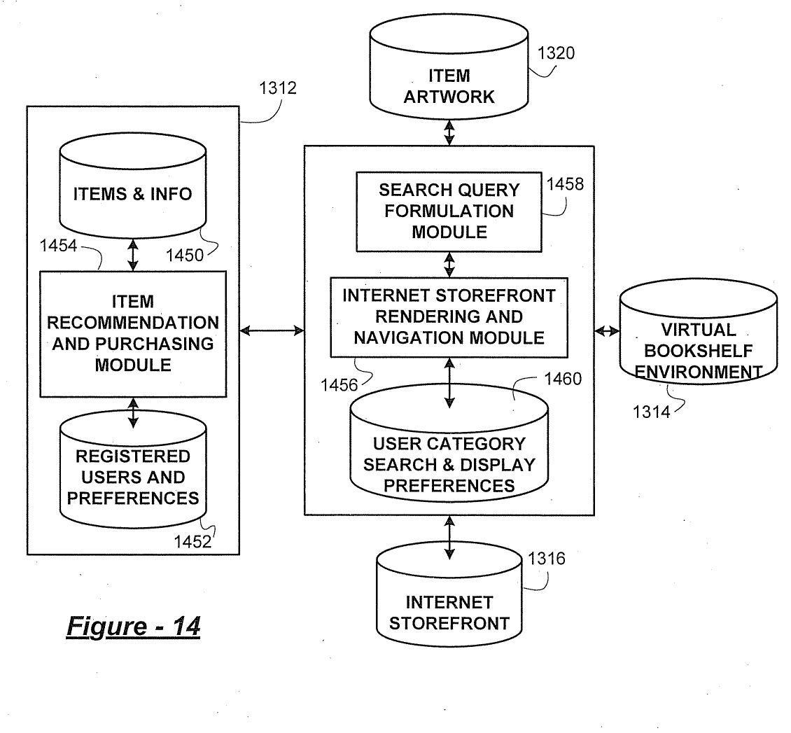

With reference to FIG. 14, the predefined criteria for populating the item windows vary. For example, the criteria include populating a row with new releases, populating a row with upcoming releases, populating a row with recommended items, populating a row with bestsellers, and populating a row with items picked according to user preferences inferred from previous user purchases, such as genre and/or author.

Turning now to FIG. 14, an item recommendation and purchasing module 1454 of the Internet ordering system 1312 accesses registered user preferences 1452 and retrieve information 1450 about items to present to the users in various predefined categories. A search query formulation module 1458 then formulates search queries for module 1454 based on the categories, and results of each category returned by module 1454 are arranged by category. The user interface connects to users by an internet storefront rendering and navigation module 1456. Returning users are recognized by cookies or the like, and preferences 1460 of the users, if any, are retrieved for determining which categories should be accommodated.

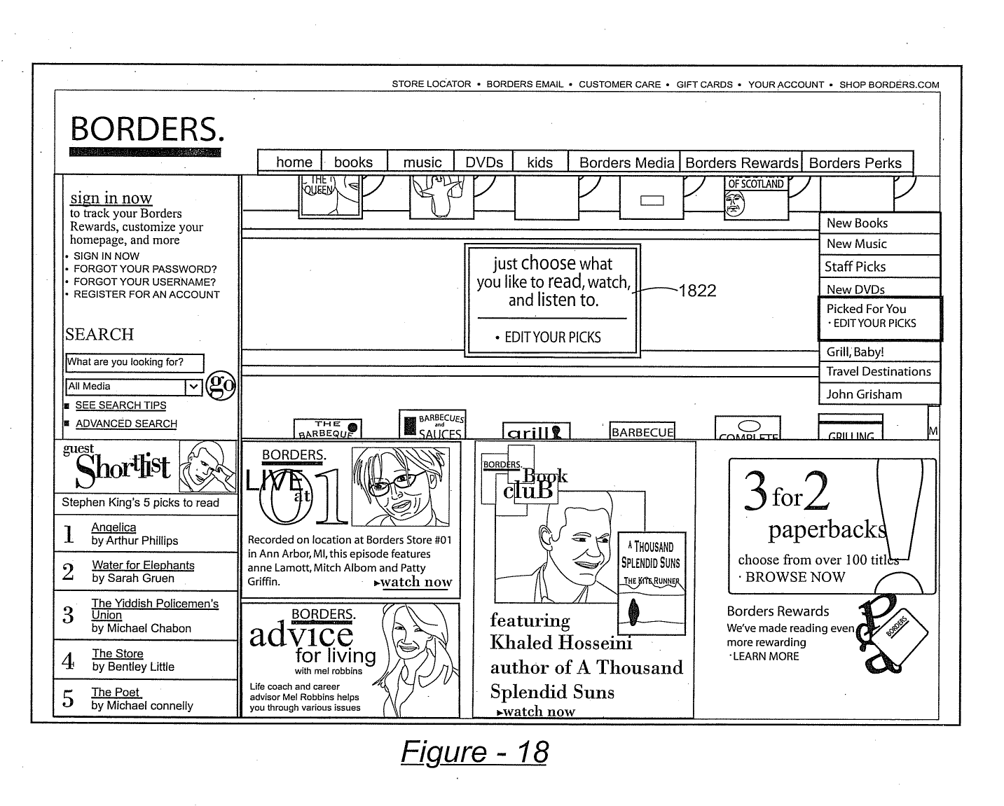

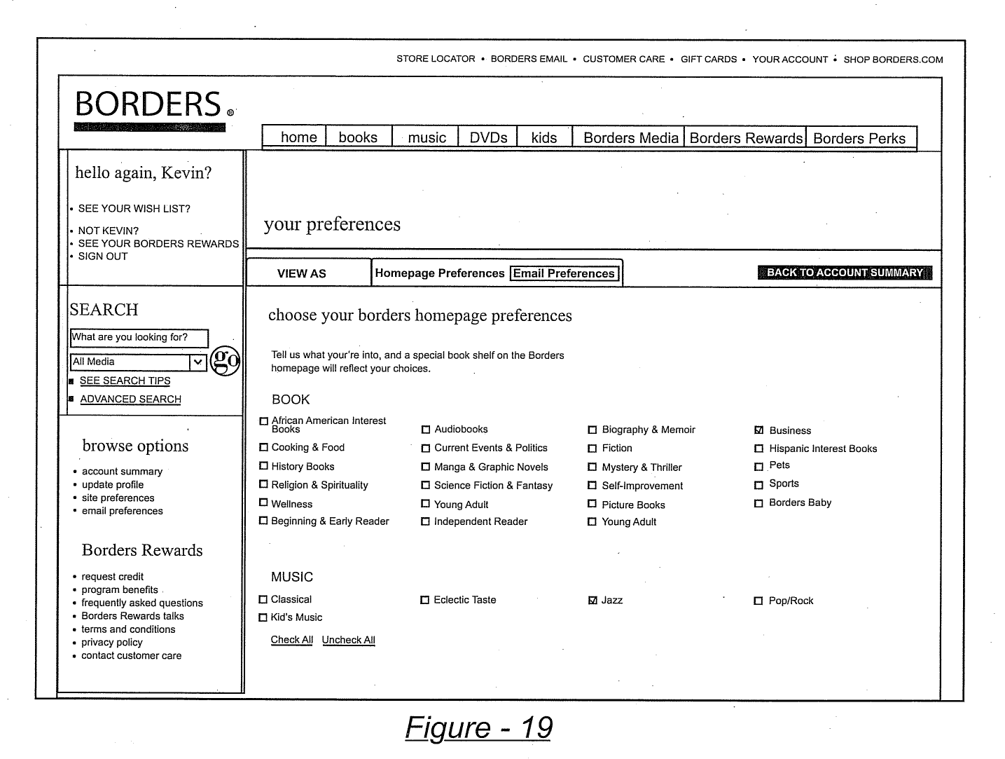

Users also specify categories of interest and configure the user interface accordingly. In one exemplary embodiment, a promotional virtual sign 1822 is interspersed on the bookshelves as shown in FIG. 18. The promotional virtual sign display various promotional messages to the user. In the illustrated embodiment, the sign 1822 suggests that the user specify areas of interest. By selecting a link on the sign, the user is presented with an interface that enables them to specify preferences as shown in FIG. 19.

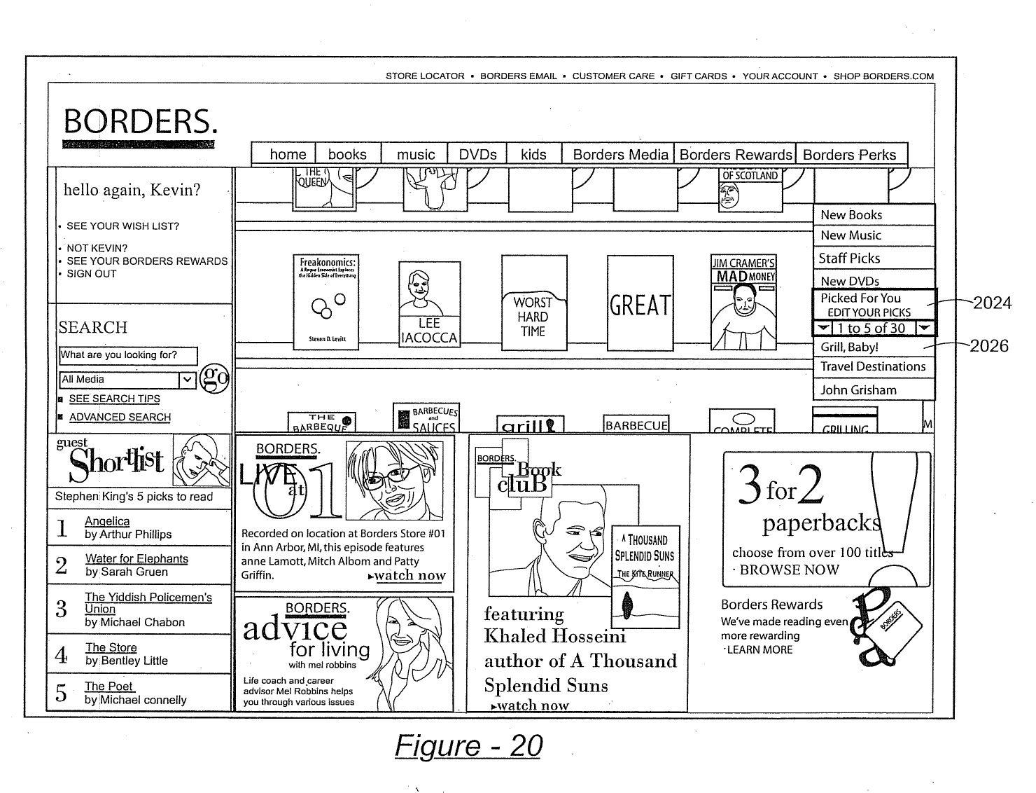

The categorical lists of items are hierarchical, and items are ordered by inferred or specified user preferences. For example, a “picked for you” category 2024 is wholly arranged by user preference as shown in FIG. 20. Also, a bestsellers category lists the absolute best sellers at the beginning of the list, but promotes other bestsellers based on user preferred genre, user preferred author, etc. to also be displayed early. In other embodiments, one or more the categories themselves are configured based upon user preferences, i.e., the “Grill, Baby” category indicated at 2026 in FIG. 20.

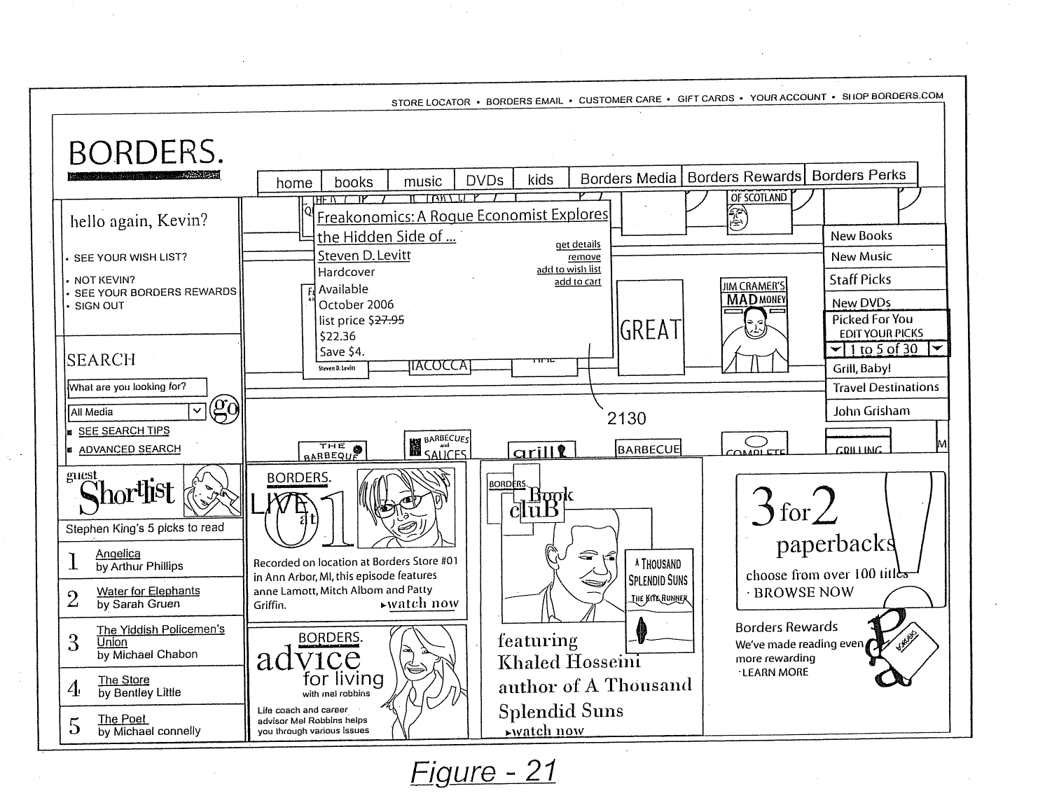

More information about an available item is displayed by selecting the item in the virtual bookshelf environment. For instance, upon selecting an item, a pop-up box 2130 having additional information for the item is displayed as shown in FIG. 21. In this example, the title, author, price, an availability of the item at a retail store as well as other information is displayed to the user. In addition, the pop-box provides further links which permit the user to order the item and/or reserve the item at a nearby by store location. If a user elects to reserve the item, the user is shown the availability of the item at various stores located proximate to the user based on the user's zip code or other indicia of location. If reserved, the system interfaces with an inventory system of the store to place the item on hold for the user. If the user elects to purchase the item, the user is led through a series of interfaces with enable the user to place an order for the item in a manner well known in the art.

The above description is merely exemplary in nature and is not intended to limit the present disclosure, application, or uses.

What is claimed is:

1. A user interface system for use with an internet ordering system, comprising:
a user-navigable, virtual bookshelf environment providing a plurality of columns and rows for displaying items for purchase within item windows aligned along visual representations of shelves bordering the rows;
a datastore of item artwork providing a visual rendering of items for purchase; and
an Internet storefront providing a view of a portion of the virtual bookshelf environment to a user,
wherein said user interface populates the item windows with item artwork according to predefined criteria, and responds to user interaction with a control of said storefront to change the view of the virtual bookshelf environment presented to the user.

2. The system of claim 1, wherein the item artwork contains elements of the visual representations of the shelves.

3. The system of claim 2, wherein the visual representations of the shelves and the item artwork have depth components, and the depth components of the item artwork are configured to complement the depth components of the visual representations of the shelves.

4. The system of claim 3, wherein the depth components include perspective and light and shadow.

5. The system of claim 2, wherein the elements of the visual representations of the shelves include shelf color pattern.

6. The system of claim 1, wherein the item artwork includes artwork rendering books, artwork rendering DVDs, and artwork rendering CDs.

7. The system of claim 1, wherein said user interface is responsive to user interaction with an instance of the item artwork rendered in the virtual bookshelf environment by displaying information about a particular item for purchase that is represented by the instance of the item artwork.

8. The system of claim 1, wherein the predefined criteria for populating the item windows include populating a row with new releases.

9. The system of claim 1, wherein the predefined criteria for populating the item windows include populating a row with upcoming releases.

10. The system of claim 1, wherein the predefined criteria for populating the item windows include populating a row with recommended items.

11. The system of claim 1, wherein the predefined criteria for populating the item windows include populating a row with new releases.

12. The system of claim 1, wherein the predefined criteria for populating the item windows includes populating a row with bestsellers.

13. The system of claim 1, wherein the predefined criteria for populating the item windows includes populating a row with items picked according to user preferences inferred from previous user purchases.

14. The system of claim 1, wherein the control of said storefront provides hierarchically arrayed, user-selectable, user interface components conveying categories assigned to the rows, and user selection of the components scrolls the partial view from row to row in a vertical direction and along the rows in a lateral direction.

15. The system of claim 1, wherein the control of said storefront provides user interface input components assigned to the rows and user selection of the components scrolls contents of the rows horizontally on an individual basis.

16. The system of claim 15, wherein user selection of one of the components causes contents of that row to scroll horizontally while contents of at least one other row rendered in the partial view remain fixed in location in the partial view.

17. A user interface system for use with an Internet ordering system, comprising:
an item database storing item information about categorized items for purchase;
an item artwork generator retrieving the item information from said item database and generating a multidimensional matrix having categorical rows of item icons representing the items, wherein the item icons are assigned to the rows by matching categories of the items to categories of the rows; and
a virtual bookshelf appearance generator receiving the multidimensional matrix, wherein the bookshelf appearance generator has an animation engine generating the virtual bookshelf appearance by retrieving bookshelf images from a data store of bookshelf images, and populating the bookshelf images with the item icons of the matrix, and said virtual bookshelf appearance generator supplies the virtual bookshelf appearance to a display frame of said user interface for display to a user by an active display.

18. The system of claim 17, wherein a data object describing an item identifies the item's item categories, rank within each category, item image, item size ratio, item type, and item promotions.

19. The system of claim 18, wherein said item artwork generator employs the item image and size ratio to generate an item icon for the item, and employs the item type to determine item image size and shape.

20. The system of claim 19, wherein the item promotions identify those promotions that are relevant to the item and therefore suitable for at least one of: (i) adding a promotion icon to the item image of the item in the item icon for the item; or (ii) adding the promotion icon to the matrix proximate to the item icon for the item.

21. The system of claim 18, wherein the item categories identify the categories to which the item has been assigned, and its assigned rank in each category.

22. The system of claim 17, wherein the item icons are arranged horizontally according to ranks of their items within the categories, and item images in the item icons have a size, shape, and image content according to information specified by the item information.

23. The system of claim 17, wherein said item artwork generator accesses a promotion datastore and uses the item information to retrieve promotion information about promotions pertaining to the items.

24. The system of claim 23, wherein the promotion information includes item categories, item types, item IDs, locations at which the promotions are valid, a promotion image, promotion size ratio, and promotion type.

25. The system of claim 24, wherein said item artwork generator employs the promotion image and promotion size ratio to generate a promotion icon, and employs the promotion type to determine promotion image size and shape.

26. The system of claim 25, wherein said item artwork generator at least one of: (a) adds the promotion icon to an item image in the item icon; or (b) adds the promotion icon to the matrix proximate to the item icon.

27. The system of claim 26, wherein said item artwork generator adds the promotion icon to the matrix in a predetermined position below the promotion icon, wherein the predetermined position is predetermined to cause the promotion to appear to be attached to a shelf of the virtual bookshelf appearance.

28. The system of claim 26, wherein said item artwork generator adds the matrix in predetermined positions of the matrix that are also employed for item icons.

29. The system of claim 26, wherein the promotion icons are linked to at least one of indicators of items for purchase or external websites of advertisers.

30. The system of claim 17, wherein the user interface allows the user to make an item selection by clicking on an item icon, and said Internet ordering system receives the item selections from the user interface and displays ordering information about the items to the user.

31. The system of claim 17, wherein one or more of the categories is a personalized category for the user, wherein item objects belonging to multiple categories at least one of selected by the user or selected for the user are retrieved and grouped together in a row of the matrix.

32. The system of claim 31, wherein the multiple categories are selected by the user by allowing the user to employ a configurator tool of the user Interface to at least one of select the multiple categories or supply search terms for inclusion in a query for retrieving items belonging to the multiple categories.

33. The system of claim 31, wherein the multiple categories are selected for the user by employing a user purchase history supplied by said Internet ordering system.

34. The system of claim 17, wherein said virtual bookshelf appearance generator receives user navigation selections from said user interface, including at least one of category selections and horizontal movement selections.

35. The system of claim 34, wherein said virtual bookshelf appearance generator responds to a category selection by animating vertical movement of the virtual bookshelf images while synchronously populating the virtual bookshelf images with the item icons, thereby causing the user to experience a change of focus at least one of upwards or downwards from one bookshelf to another within a virtual bookshelf environment provided by the virtual bookshelf appearance.

36. The system of claim 34, wherein said virtual bookshelf appearance generator responds to horizontal movement selections for a row by animating horizontal movement of item images only in that row.

37. The system of claim 36, wherein said user interface adds a grey border to the item icons that creates an appearance of depth for the item images, wherein the border changes color when the user places a pointer over the item image.
